(19) United States
(12) Patent Application Publication
(10) Pub. No.: US 2016/0338387 A1
(43) Pub. Date: Nov. 24, 2016

(54) USE OF A NATURAL ADHESIVE WITH A FOODSTUFF

(71) Applicant: YNuts, LLC, New York, NY (US)

(72) Inventors: David AVITAL, New York, NY (US); Pernilla AVITAL, New York, NY (US)

(21) Appl. No.: 14/949,193

(22) Filed: Nov. 23, 2015

Related U.S. Application Data
(60) Provisional application No. 62/164,178, filed on May 20, 2015.

(51) Int. Cl. A23L 1/36

(52) U.S. Cl. CPC A23L 1/364; A23V 2002/00

(57) ABSTRACT

A natural adhesive can be used in a flavored foodstuff, the natural adhesive at least partially coating a nut, and a seasoning adhered to the natural adhesive. A novel flavored foodstuff is disclosed, utilizing the natural adhesive to adhere seasoning to a roasted nut and method of making the novel foodstuff is also disclosed.

### BACKGROUND OF THE INVENTION

The present application claims priority to, and incorporates by reference in its entirety, U.S. Provisional Application No. 62/164,178, filed on May 20, 2015.

Mass produced foods have been both a boon and bane for society. Modern processes have enabled production of large quantities of food to be available at moderate costs for a large number of people. Additives to the food, such as flavoring, coloring, and preservative ingredients, both chemical and biologic have also increased shelf-life, appearance, texture, and palatability of the food.

Like other great contributions to society however, mass produced foods have also increased certain health risks with their consumption. Large quantities of food are processed at unethically high speeds for efficiency resulting in low safety standards, poor food quality, low cleanliness standards, toxins from cleaning chemicals and the machinery, and subsequently food poisoning outbreaks arise from the methods of food preparation in factories. Other consequences of mass produced food are the epidemic of obesity, death of children due to food borne illness and allergy contaminates, and the poor effect on the environment.

Nuts, both tree nuts and legumes, are a popular mass produced snack and small meal item. Nuts may be prepared for consumption a number of different ways, including roasting, dry-roasting, salting (with or without roasting), or boiling, to name a few.

In order to improve the flavor of nuts, they have long been roasted. Roasting is generally accomplished using either heated air or hot oil. Roasting is generally carried out at elevated temperatures by introducing nuts into a roasting oven, maintaining the heat or introducing heat to bring the nut up to a roasting temperature, e.g., 100° C.-200° C., and maintaining the heat at that temperature until the nuts reach proper taste and texture. Additionally, flavor of the roasted nuts can be further improved with the use of coatings and/or flavor oils.

For example, U.S. Pat. No. 4,161,545 discloses a method for applying a honey based coating to nuts. Similarly, U.S. Pat. No. 3,671,766 discloses a process for coating nuts with hexatol containing compositions. U.S. Pat. No. 4,053,650 discloses a method for coating nuts with cereal and wheat flour compositions which are baked onto the roasted nut. U.S. Pat. No. 4,085,230 discloses a process for processing nuts which includes an initial step of cooking the nuts in boiling water for a period of time before roasting. In a final coating step salt and flavoring are applied to the cooled nuts.

Nuts may also be blanched in addition to roasting and/or salting. Blanching is a process wherein the nut is plunged into boiling water, removed after a brief, timed interval, and finally plunged into iced water or placed under cold running water in order to halt the cooking process. U.S. Pat. No. 3,457,087, for example, discloses a method for eliminating “spotting” on nuts which is associated with blanching and roasting processes. The process involves the quenching of hot roasted nuts in copious amounts of cold oil which is said to be absorbed into the nut. Flavorings can be included in the quench oil.

During the initial part of a nut roasting process water is removed from the nut which generally has an initial moisture content of about 4% to 8% by weight. Until the water content is reduced to about 1.5% to 2.5% no browning or flavor development occurs. In addition to loss of water and other volatiles such as aromatics and air the cell structure expands and nut oil moves out of the nut kernel to its surface.

As a result of the loss of volatiles thermal expansion of the nut occurs, forming many small cracks and fissures in the nut. According to U.S. Pat. No. 3,457,087, at this point the nut should be capable of absorbing flavorings readily. However, flavoring added to the hot nuts are generally volatilized and only a minor amount, if any, remains to be absorbed by the nut. Once the nut has cooled the surface oil is absorbed, the nut contracts and the moisture content is equilibrated with the ambient conditions that is about 2% by weight moisture.

As a result of these physical phenomena of the nut during roasting and cooling, the prior art processes fail to impart substantial flavor to the nut itself. In the process of U.S. Pat. No. 3,457,087, for example, the cold oil is applied to hot nuts and as a consequence the flavoring is volatilized in the region immediately adjacent to the nut. There has been a failure in the prior art to recognize that nut surface temperature during the application of flavorings to nuts is critical if the flavoring is to be absorbed rather than remain merely as a surface coating.

While traditional roasting and/or salting or coating methods add flavor to nuts, there are considerable drawbacks associated therewith. Some major limitations of flavoring of nuts such as deep fat fried/dry roasted cashew nuts/peanuts with powdered spices include: (1) presence of thermo resistant bacterial load, which creates safety problems during storage. (2) Non-uniformity of the flavor quality (3) reduced impact of natural spice flavor, and (4) rapid loss of aroma during storage and presence of intense colored spots randomly distributed throughout the surface of the nut. In order to sustain a continuous demand for spiced nuts it is necessary to develop alternate flavorings as well as well as methods of application. The problems encountered by using powdered spices can be overcome to a large extent by developing suitable method of using spice oleoresins to flavor the processed nuts. By definition, an oleoresin is the total soluble extractives of a material in a specified solvent. In flavor work the best oleoresin is that which is a concentrate of all the flavor components (aroma, taste, pungency, and related sensory factors) and which truly recreates, when diluted, the sensory quality of the original natural material. Oleoresins do not have many of the disadvantages inherent in the use of powdered spices in terms of flavored quality, uniformity, and separation of storage. At the same time oleoresin offer convenience, while using in food industry or large-scale preparation.

Reference may be made to U.S. Pat. No. 4,738,865, in which an adhesive for adhering flavoring is disclosed, and which is a mixture of a reducing sugar preferable lactose and a maltodextrin. The adhesive is particularly useful for coating peanuts with a dry honey coating providing honey coated and salted nuts. Reference may also be made to U.S. Pat. No. 4,931,304, describing a process for flavoring edible nuts which comprises roasting of nuts, partially cooling the nuts to about 56° C. to 92° C., applying a volatile flavoring agent and blending the nuts until the flavor agent is absorbed by the nuts.

Reference may be made to U.S. Pat. No. 5,194,278, which relates to edible cores, especially nuts (peanuts, cashews, etc.) having a desirable fruit flavoring. More particularly, the invention relates to edible cores which are prepared by coating with an adhesive solution containing a source of fruit flavoring, and then roasting to provide a snack having desired toasted taste and appearance.

Reference may be made to U.S. Pat. No. 5,061,499, which describes coating the raw nuts (peanuts, cashews, etc.) with an adhesive solution containing honey, corn syrup, sucrose, carbohydrate gum and water followed by a coating of powdered sugar, roasting the nuts preferably in oil, and then applying a coating of a dry mixture of sugar and salt. The final coating is tightly adherent after roasting.

Reference may be made to U.S. Pat. No. 5,939,119, which describes a process for coating nuts by immersing the nuts in a molten edible material to coat the nuts with molten edible material, separating the excess molten edible material and then cooling the coated nuts to solidify the molten edible materials. Reference may be made to U.S. Pat. No. 5,093,139, relating to a method of preparing roasted sunflower shells containing seeds having a generally uniform coating of a flavoring agent. A liquid flavor containing a coating solution is used in the form of a spray.

Reference may be made to U.S. Pat. No. 4,692,342, describing a process for honey-roasting nuts by applying a predusting of a minor amount of an adhesive, film-forming material, honey and water; enrobing the adhesive coated nuts with a dry mixture of honey sugar and salt; and subjecting the coated nuts to roasting, preferably air roasting. Reference may also be made to U.S. Pat. No. 4,161,545, which describes coating nuts with the combination of honey and water followed by enrobing with a dry mixture of sugar and starch and the nuts are then roasted. Starch may also be used to coat nuts, as in U.S. Pat. No. 4,769,248. This patent relates to the a process for preparing dry roasted nuts, comprising applying a uniform coating of a starch to raw nuts, applying a uniform coating of a gelatin solution to the starch coated nuts by applying a coating of a seasoning mix to the coated nuts, and roasting the resulting nuts.

There remains a need, therefore, to provide a healthy coating and adhesive to use to obtain a good tasting, nutritious nut foodstuff.

### SUMMARY

Provided therefore herein is a flavored foodstuff including a nut, a natural adhesive comprising Yerba Mate, the natural adhesive at least partially coating the nut, and a seasoning at least partially coating the nut, the seasoning adhered to the nut with the adhesive. In an embodiment, the flavored foodstuff is a natural oven roasted nut. In another embodiment, the nut is selected from the group of almonds, walnuts, pecans, hazelnuts, and pistachios. In another embodiment, the nut is an almond.

In an embodiment, the seasoning is selected from grapefruit juice, lemongrass juice, rind from fresh mandarin oranges, nutmeg, cinnamon, coffee, Tahitian vanilla, cloves, buckwheat honey, raspberries, ginger, basil, rosemary, cheddar, apple, and mixtures thereof. In another embodiment the seasoning is selected from the group of salts, sea salts, and unprocessed salts.

In an embodiment, the seasoning and the adhesive are mixed together to form a seasoned adhesive mixture prior to at least partially coating the nut. In an embodiment, the unprocessed salt is selected from group of Hawaiian Alaea salt, marsh salt (which may be Celtic Sel Gris), Black lava sea salt (preferably Hawaiian), Pink Rock salt (preferably Himalayan), white sea salt, and combinations thereof.

The present invention also provides a method of using a natural adhesive in making a flavored foodstuff. The method includes providing a natural adhesive including yerba mate, and at least partially coating a nut with the adhesive. The yerba mate adhesive may be made by grinding leaves from yerba mate plant into smaller components, and optionally adding a solvent to make a pasty solution, applying the pasty solution to a nut, a seasoning may also be optionally mixed with the yerba mate to form a seasoned adhesive mixture.

In an embodiment the flavored foodstuff is a natural oven roasted nut. In an embodiment, the seasoned adhesive mixture at least partially covers the nut. In another embodiment, seasoned adhesive mixture substantially covers the nut. In yet another embodiment, the nut is coated with a pasty solution formed by the adhesive and seasoning with a third component to enhance mixing, before or after roasting in a natural oven.

In another embodiment, a method of making a natural foodstuff comprising a nut is provided. The method includes heating a nut, mixing a natural adhesive including Yerba Mate with a seasoning to form a flavored adhesive mixture, and adding the flavored mixture to the nut after said heating.

In another embodiment, the present invention includes a method of making a natural foodstuff including a nut. The method includes heating a nut, mixing a natural adhesive including yerba mate with a seasoning to form a seasoned adhesive mixture, and adding the seasoned adhesive mixture to the nut after said heating.

For a better understanding of the present invention, together with other and further objects and advantages, reference is made to the following detailed description, taken in conjunction with the accompanying examples, and the scope of the invention will be pointed out in the appended claims. The following detailed description is not intended to restrict the scope of the invention by the advantages set forth above.

### DETAILED DESCRIPTION

In order to dry roast and salt nuts healthily, a natural adhesive was discovered for getting salt to stick to a surface of a nut properly. When the Yerba Mate herb (also known as simply Mate), which is mostly utilized as a cultural and medicinal tea drink, is ground into a fine powder and mixed with small amounts of water it results in a sticky, green paste. The paste is coated directly on the nut surface before salting to better adhere the salt particles. The Yerba Mate herb is composed mostly of polyphenols, xanthenes, caffeoyl derivatives, saponins, and minerals which are responsible for most of the pharmacological benefits.

Polyphenols are naturally occurring molecules found in plants which provide structural support, can relieve chronic pain, have antibacterial properties, and help reverse oxidative damage to artery walls. Polyphenols are sticky in property and these molecules are what allow the herb to function as a glue substance. The Yerba Mate herb is touted largely for its energizing effect, due in part to the caffeine content, but it is also well known for its antioxidants; antimicrobial, cardiovascular, chemopreventative, and neuroprotective properties; as well as its use to stimulate the digestive system, promote weight loss, relieve pain and headaches, slow the aging process, and its general use as a health tonic. The various pharmological uses and the significant energizing benefits of the Yerba Mate herb will only increase the demand of salted roasted nuts as a naturally healthy snack.

The use of Yerba Mate herb is a healthier and organic method of adhering salt to roasted nuts with the added benefit of energy boosting properties and general, potential health benefits like pain relief and weight loss. Using the Yerba Mate herb avoids a need for extra fat in oil or butter, extra salt in a brine solution, or a processed sugar-based “gum” like xanthan gum as an adhesive.

As used herein, the term “Yerba Mate” or “Mate” refers to the plant Yerba Mate, and anything derived therefrom. Yerba Mate is a species of the holly family (Aquifoliaceae), with the botanical name Ilex paraguariensis. It is contemplated within the invention that other components known in the art may be combined with Yerba Mate to be used as an adhesive. Alternatively, Yerba Mate may also be used as a seasoning, or additive, and not for its adhesive functionality.

As used herein, the term “nut” refers to any kernel found within a shell, and generally used in food, and includes both tree nuts and legumes. A nut is generally known as any hard-walled edible kernel which is typically a fruit composed of a hard shell and a seed, and is generally edible. Some examples of nuts include, without limitation, almonds, peanuts, hazelnuts, chestnuts, acorns, pecans, pistachios, walnuts, Brazil nuts, candlenut, cashews, macadamia, mongono, pine nut, walnut, and Yeheb nut.

As used herein the term “seasoned,” “seasoning,” or “season(s)” refers to any salt, herbs, spices, fruits, cheeses, oils, or any other ingredients used to enhance the overall organoleptic qualities of the ready-to-eat seasoned foodstuff. Some examples include, but are not limited to, grapefruit juice, lemongrass juice, rind from fresh mandarin oranges, nutmeg, cinnamon, coffee, Tahitian vanilla, cloves, buckwheat honey, raspberries, ginger, basil, rosemary, cheddar, apple, and mixtures thereof.

As used herein the term, “natural oven roasted nut” refers to a roasting process utilizing natural methods, including stone roasting (e.g., soapstone, slate, or lava rocks), charcoal roasting, or other natural roasting processes. Such roasting methods are disclosed in concurrently filed applications, attorney docket numbers 2481-3P, 2481-4P, 2481-5P, and 2481-6P, the entirety of which are herein incorporated by reference.

The process of the invention can be applied to any of those edible nut varieties, including tree and ground nuts, which are conventionally packaged and sold as snack-type products. Illustrative of such nut meats are peanuts, cashews, almonds, walnuts, filberts, macadamia nuts, pecans, and the like.

The nuts may be deshelled in a preliminary step and, optionally are also subjected to other conventional procedures such as blanching and the like, prior to being subjected to the process of the invention. When the nuts are ready to be roasted, they are subjected to roasting under conditions which may vary depending upon the particular type of raw nut and the type of roasting process, be it oil or air (i.e., dry) roasting. Illustratively, the nuts are roasted at temperatures within the range of from about 200° F. to about 450° F., for a time which will vary depending upon the particular roasting temperature employed, the particular type of nut being processed, and the degree of roasting desired. For example, the time and extent of roasting will be greater in the case of peanuts than in the case of cashews. The most appropriate roasting conditions to be adopted in any particular instance can be determined readily by a process of trial and error.

The roasting operation can be conducted on a batch or continuous basis. The residence time of the nuts in the oven is adjusted to provide the desired time of roasting; e.g., a range of about one minute to about 30 minutes. Any of the apparatuses conventionally employed in the art to effect the dry roasting of nuts can be utilized in the above batch or continuous roasting step. It is an advantage of the present invention that superior results are achieved when air roasting nuts coated in the manner described above.

In another embodiment, the seasoning and the natural adhesive are mixed together to form a seasoned adhesive prior to at least partially coating the nut. In an embodiment, the seasoning and the natural adhesive are mixed in a ratio of from about 1/20 of adhesive/salt to about ⅕ of adhesive/salt.

The nuts disclosed herein can also optionally be coated with any type of flavorant, or seasoning. Some examples include, non-exhaustively, allspice, anise, basil, beau monde seasoning salt, caraway, cardamom, pepper, chives, cilantro, five spice Chinese powder, garlic, ginger, juniper berries, mace, marjoram, mei yen seasoning, mint, mustard, nutmeg, oregano, paprika, parsley, pine nuts, poppy seed, pumpkin pie spice, rosemary, saffron, sage, savory, salt, sea salt, sesame seeds, shallot, soy sauce, tabasco, tarragon, thyme, turmeric, worcestireshire sauce, and zest.

Yerba Mate contains the following beneficial vitamins, minerals, etc.:
Vitamins: A, C, E, B1, B2, Niacin (B3), B5, B Complex.
Minerals: calcium, manganese, iron, selenium, potassium, magnesium, phosphorus, and zinc.
Additional Compounds: carotene, fatty acids, chlorophyll, flavonols, polyphenols, inositol, trace minerals, antioxidants, tannins, pantothenic acid and 15 amino acids.
Theophylline, theobromine, and caffeine.

Yerba mate contains a large amount of antioxidant and pohlyphenols. Polyphenols contain antioxidant properties and have been found to aid in the prevention of several degenerative diseases, including cardiovascular disease (CVD) and cancer. Yerba mate has significant antioxidant activity. In a study published in 1995 by Biochemicaland Molecular Biology International, researchers concluded that water extracts of yerba mate “were more potent antioxidants than either ascorbic acid (vitamin C) or butylated hydroxytoluene.” A few years later, a group of researchers embarked on a study to again investigate the antioxidant properties of Ilex paraguariensis infusions. Those findings were published in March of 2000 in the journal Biochemical and Biophysica Research Communications. Their results suggest “that ingestion of extracts of Ilex paraguariensis could contribute to increase the antioxidant defense of an organism against free radicals attack.” In a more recent study, published in the November 2001 issue of Fitoterapia, researchers took a look at seven different plant species in South America. They found that yerba mate “contained a higher content of flavonoids and caffeoyl derivatives than any other assayed species.”

Yerba Mate is also a good source of xanthines, caffeoyl derivatives and saponins.

Yerba Mate herb may be ground down into a fine powder. It is then blended with minimal amounts of water in order to formulate a thick, sticky paste that will be coated on the nuts. Adding a small dash of salt to the paste will allow it to coat and stick more effectively. After the nuts are coated in the paste, they are tossed in salt until coated generously because every salt particle won't properly adhere so this will ensure a more even spread of salt. After the nuts are thoroughly salted, they are then roasted at 300° F. for approximately 30 minutes which allows the Yerba Mate coating and salt to set.

Some benefits of consuming yerba mate include taking advantage of its following properties, such as antioxidant properties. Consumption of yerba mate provides antioxidant benefits to the body. It has many different phytochemicals such as polyphenols, chlorogenic acid and caffeoyl derivatives that make it a beneficial antioxidant. Research suggests that mate extract may reduce oxidative stress that increases risk of damage to liver and heart. It also reduces nitrosative stress that may cause DNA damage, cell death and lipid peroxidation. As compared to green tea yerba mate is more effective in preventing cytotoxicity associated with blood flow restriction heart disorders such as stroke etc.

Another benefit includes cardiovascular benefits. Yerba mate contains compounds such as polyphenols that may be beneficial in reducing risk of cardiovascular diseases such as atherosclerosis. Findings of a research study suggests that intake of yerba mate has beneficial impact on lipid parameters and it helps to reduce LDL cholesterol in hypercholesterolemic people. Consumption of yerba mate protects myocardial tissue of the heart and is also beneficial in reducing oxidative stress caused by reactive oxygen species (ROS) which may cause stroke etc.

It also possesses antimicrobial properties. Research results of a study conducted to ascertain effects of yerba on E. coli suggests that it has antimicrobial properties that may help in preventing health risks caused by E. coli bacteria. Due to this it has the potential to be used as antimicrobials in various beverages and foods against E. coli. It also has significant anti-inflammatory properties. The flavanoids found in yerba mate may be beneficial in reducing inflammation. Anti-inflammatory properties make yerba mate beneficial in reducing risk of chronic disease and therefore improving overall health. It also possesses anti-cancer properties. Health benefits of yerba mate include prevention of cancer. Several studies have been conducted to evaluate the anticancer properties of yerba mate and the findings suggest that it indeed has the potential to protect human body against cancer. Yerba mate may be beneficial and reducing complications from hyperglycemia in diabetes. Hyperglycemia results in dicarbonyls which causes many diabetic complications. Yerba mate as an antioxidant plays role in the process of glycation which reduces the dicarbonyl action, resulting oxidation and hyperglycemia. Yerba mate has also been shown to have beneficial health effect in reducing obesity. This weight loss effect of yerba mate is attributed to increased fat oxidation, slowing of gastric emptying and increased feeling of satiety.

In a preferred embodiment, a natural, unprocessed salt may be used in with the nuts made in the process of the present invention. Such nuts with unprocessed salts are disclosed in concurrently filed application number 2481-8P, which is herein incorporated by reference in its entirety.

### EXAMPLES

The present invention is further exemplified, but not limited, by the following representative examples, which are intended to illustrate the invention and are not to be construed as being limitations thereto.

### Example 1

The following ingredients are used in making a flavored foodstuff according to the presently claimed invention.

### INGREDIENTS

1 cup of water (8 oz)
½ tea spoon of Yerba Mate (0.0154 oz)
1 tea spoon of salt, comprised of one (or combination) of the following:
Red salt (0.0950 z)
Black salt (0.1146 oz)
White salt (0.1670 oz)
Grey salt (0.1425 oz)
Pink salt (0.1935 oz)

Procedure

The salt, in this case extra fine grain Himalyayan salt (alternatively, can use Sel Gris Celtic salt, Alaea red Hawaiian salt, organic sea salt, Hiwa Kai black lava salt), is put in a large mixing bowl with 1 cup of water (8 oz) and ¼ tea spoon of Yerba Mate (0.0154 oz), and mixed for 30 minutes.

The nuts, in this case the almonds, are spread flat on a natural surface slab, in this case soapstone (slate rock and lava rock may also be used). The soapstone slap is placed within a hot gas burning oven. The oven is pre-heated for about 10 minutes to about 350° F.

The almonds are roasted at 350° F. (or generally between 270° F. and 390° F.) for 8 minutes, or until a nutty aroma wafts out of the oven. The almonds should be a golden brown color. The almonds are then removed from oven on the slab and placed on a heat-resistant surface.

The hot almonds are immediately coated with the fine grain Himalayan salt and the powder Yerba Mate mixture. The almonds have to be cooled entirely prior to being served or packaged. The temperatures and times given above are those that are preferred. Obviously they may be varied based on the oven and amount of nuts roasting, roasting slab choice, and type of nut being roasted.

The above and other beneficial objects and advantages are accomplished in accordance with the present invention by a preconditioning process for the nuts, which comprises:

(a) storing the nuts in a conditioned environment having a temperature in the range of about 45 degrees F. to 55 degrees F. for sufficient time that the temperature of substantially each nut is uniform between its center and surface, and
(b) uniformly heating the conditioned nuts with heated air so as to cause the surface cells of the nuts to expand.

Raw nuts and seeds, generally having been stored at low preserving temperatures, are placed in open bins in layers having a depth between about 24 and 48 inches. Air having a temperature in the range of 78 degrees F. to 95 degrees F. is circulated around and through the bins for about 24 hours. Such treatment produced a conditioned nut product wherein the temperature of substantially each nut is uniform between its center and surface. In the absence of the conditioning treatment, the nuts will undergo internal scorching during the subsequent heat treatment.

The conditioned nuts are subsequently subjected to treatment with heated air which causes the surface cells of nuts to expand. Although the air temperature and time of exposure will vary with each nut or seed product because of its size and cellular structure, air temperatures will generally be in the range of 300 degrees F. to 400 degrees F., and exposure times will generally be in the range of 3 to 8 minutes. The heated nuts, having a slightly expanded surface, are highly permeable to a sodium chloride solution, especially when the nuts are still at an elevated temperature at the instant of application of the solution.

Nuts and seeds susceptible to improvement by the process of this invention are free of an intact inedible outer shell. Typical species include nuts such as almond, pecan, walnut, peanut, pistachio, macadamia, hazel, brazil, cashew, and sees such as pumpkin, and sunflower.

Thus while there have been described what are presently believed to be preferred embodiments of the invention, those skilled in the art will realize that changes and modifications may be made thereto without departing from the spirit of the invention, and it is intended to claim all such changes and modifications as fall within the true scope of the invention.

What is claimed is:

1. A flavored foodstuff comprising a nut, a natural adhesive comprising yerba mate, said natural adhesive at least partially coating said nut, and a seasoning at least partially coating said nut, said seasoning adhered to said nut with said adhesive.

2. The flavored foodstuff according to claim 1 wherein said nut is a natural oven roasted nut.

3. The flavored foodstuff according to claim 1 wherein said nut is selected from the group of almonds, walnuts, pecans, hazelnuts, and pistachios.

4. The flavored foodstuff according to claim 1 wherein said nut is an almond.

5. The flavored foodstuff according to claim 1 wherein said seasoning is selected from grapefruit juice, lemongrass juice, rind from fresh mandarin oranges, nutmeg, cinnamon, coffee, Tahitian vanilla, cloves, buckwheat honey, raspberries, ginger, basil, rosemary, cheddar, apple, and mixtures thereof.

6. The flavored foodstuff of claim 1 wherein said seasoning is selected from the group of salts, sea salts, and unprocessed salts.

7. The flavored foodstuff of claim 6 wherein said seasoning and said adhesive are mixed together to form a seasoned adhesive mixture prior to at least partially coating said nut.

8. The flavored foodstuff according to claim 6 wherein said unprocessed salt is selected from group of Hawaiian Alaea salt, Celtic Sel Gris french marsh salt, Black Hawaian lava sea salt, Pink Himalayan Rock salt, White Sea Salt, and combinations thereof.

9. A method of using a natural adhesive in making a flavored foodstuff comprising providing a yerba mate adhesive, and at least partially coating a nut with said yerba mate adhesive.

10. The method of using a natural adhesive according to claim 9 wherein said nut is roasted.

11. The method of claim 9 wherein said adhesive is mixed with a seasoning, and wherein said adhesive and seasoning form a seasoned adhesive mixture.

12. The method of using a natural adhesive according to claim 11 wherein said seasoned adhesive mixture at least partially covers said nut.

13. The method according to claim 11 wherein said seasoned adhesive mixture substantially covers said nut.

14. A method of making a natural foodstuff comprising a nut, said method comprising heating a nut, mixing a natural adhesive including yerba mate with a seasoning to form a seasoned adhesive mixture, and adding said seasoned adhesive mixture to said nut after said heating.
